(19) United States
(12) Patent Application Publication
(10) Pub. No.: US 2012/0176998 A1
(43) Pub. Date: Jul. 12, 2012

(54) Method for Dynamically Controlling an Uplink Transmission Power of a User Equipment

(76) Inventors: Robert Muellner, Munchen (DE); Carsten Ball, Munchen (DE); Kolio Ivanov, Munchen (DE)

(21) Appl. No.: 13/497,087

(22) PCT Filed: Sep. 24, 2009
(86) PCT No.: PCT/EP2009/062387

§ 371 Date: Mar. 20, 2012

(51) Int. Cl. H04W 52/08; H04W 52/14

(52) U.S. Cl. 370/329

(57) ABSTRACT

It is described a method for dynamically controlling an uplink transmission power of a user equipment assigned to a base station within a cell of a mobile network. The method includes determining a current traffic load within the cell, triggering in response to a specified trigger point an adaptation of the uplink transmission power of the user equipment, and controlling the uplink transmission power of the user equipment in response to the triggering and depending on the current traffic load.

### FIELD OF INVENTION

The present invention relates to the field of dynamically controlling transmission power within networks. In particular, the present invention relates to a method for dynamically controlling an uplink transmission power of a user equipment. Further, the present invention relates to a user equipment. Moreover, the invention relates to a base station. Furthermore, the invention relates to a system.

### ART BACKGROUND

In networks, especially in mobile wireless communications such as 3GPP Long Term Evolution, multiple processes have to be performed, such as delivering text, music, video and other multimedia content. More and more mobile radio users will enjoy multimedia services thus increasing the total bandwidth demand in mobile networks. With the perspective to make the next evolutionary step beyond High-Speed Packet Access (HSPA), 3GPP Release 8 has standardized Long Term Evolution (LTE) providing mobile broadband access with high data rates and low latency. In the network performance Power Control (PC) plays an important role for both maintaining a desired Signal over Interference plus Noise Ratio (SINR) according to Quality of Service (QoS) requirements and controlling the interference. Especially uplink (UL) PC is a means to effectively reduce interference in the network and to improve cell edge performance. This is of particular importance considering the fact that typical LTE deployments will have a frequency reuse 1. Due to the low transmission power of the User Equipment (UE) (for example up to 23 dBm for UE power class 3) the UL is the limiting link to balance throughput.

Any improvement for the UL throughput provides important LTE performance improvements.

The total transmission power of the UE can be distributed over many resource blocks (RB) resulting in low SINR and consequently low number of transmitted user bits per RB or it can be distributed over a low number of RB with high SINR and user bits per RB. The best strategy depends on traffic load conditions.

A common LTE UL PC algorithm is based on a combination of open-loop (OL) and closed-loop (CL) schemes. The UE controls its output power such that the power per RB is kept constant irrespective of the allocated transmission bandwidth. One RB is the smallest scheduling unit occupying a bandwidth of 180 kHz and a Transmission Time Interval (TTI) of 1 ms.

OLPC is performed autonomously by the UE and can compensate for long-term channel variations such as path-loss (PL) changes and shadowing, but its performance typically degrades due to errors in UE PL estimates.

CLPC is less sensitive to these errors due to feedback control from the LTE base station (eNodeB) based on measurements and control commands. CLPC performance degrades during UL transmission breaks due to lack of measurements as well as in case of outdated control information, e.g. due to high UE speed. As long as there is no PC command received from eNodeB on the Physical Downlink Control Channel (PDCCH), the UE exclusively performs OLPC based on PL estimates, broadcast system parameters and dedicated signalling. Whenever the UE receives a CLPC command from eNodeB via PDCCH the UE has to correct its transmission power, if necessary.

There may be a need for providing a reliable method for dynamically controlling an uplink transmission power of a user equipment.

### SUMMARY OF THE INVENTION

This need may be met by the subject matter according to the independent claims. Advantageous embodiments of the present invention are described by the dependent claims.

According to a first exemplary aspect of the invention there is provided a method for dynamically controlling an uplink transmission power of a user equipment assigned to a base station within a cell of a mobile network, wherein the method comprises determining a current traffic load within the cell, triggering in response to a specified trigger point an adaptation of the uplink transmission power of the user equipment, and controlling the uplink transmission power of the user equipment in response to the triggering and, thus, depending on the current traffic load.

This aspect is based on the idea to provide a definition of trigger conditions for the optimization of the UL transmission power based on traffic load, cell environment and quality aspects and its dynamic adaptation. The idea results from detailed studies of the interworking between UL PC, Adaptive Transmission Bandwidth (ATB), and Adaptive Modulation and Coding (AMC). The method can be applied for both modes of LTE operation, Time Division Duplex (TDD) and Frequency Division Duplex (FDD).

A common LTE PC algorithm is based on a combination of open-loop (OL) and closed-loop (CL) schemes. The UE controls its output power such that the power per resource block (RB) is kept constant irrespective of the allocated transmission bandwidth. One RB is the smallest scheduling unit occupying a bandwidth of 180 kHz and a Transmission Time Interval (TTI) of 1 ms. OLPC is performed autonomously by the UE and can compensate for long-term channel variations such as path-loss (PL) changes and shadowing, but its performance typically degrades due to errors in UE PL estimates. CLPC is less sensitive to these errors due to feedback control from the LTE base station (eNodeB) based on measurements and control commands. CLPC performance degrades during UL transmission breaks due to lack of measurements as well as in case of outdated control information, e.g. due to high UE speed. As long as there is no PC command received from eNodeB on the Physical Downlink Control Channel (PDCCH), the UE exclusively performs OLPC based on PL estimates, broadcast system parameters and dedicated signalling. Whenever the UE receives a CLPC command from eNodeB via PDCCH the UE has to correct its transmission power, if necessary. In general the transmission power for the Physical Uplink Shared Channel (PUSCH) is set by the UE according to the following equation:

P=min{Pₘₐₓ,10·log₁₀M+P₀+α·PL+Δ_{TF}+Δᵢ}. (1)

wherein
Pₘₐₓ is the maximum allowed UE transmission power specified at 23 dBm (200 mW) for UE power class 3. Pₘₐₓ is a broadcasted parameter that can be also configured to a lower value than that defined by the UE power class.
M is the bandwidth of the PUSCH resource assignment to a specific UE expressed in number of RBs.
P₀ is the set-point comprising cell specific and UE specific components to define the target receive level.
αε{0, 0.4, 0.5, 0.6, 0.7, 0.8, 0.9, 1} is a broadcasted cell-specific parameter defining the degree of PL compensation for fractional PC (FPC). The term fractional relates to the fact that only a fraction (α) of the PL is compensated. This, in general, leads to a lower transmission power.
PL is the downlink PL estimate calculated by the UE.
Δ_{TF} is a Transport Format (TF) dependent offset used to consider different SINR requirements for various Modulation and Coding Schemes (MCS).
Δᵢ represents the power correction value provided by CLPC. Optionally the correction can be either accumulative or absolute, which is signaled by the network. The method by which the closed-loop correction values Δᵢ are generated is not standardized, hence a variety of algorithms are feasible for implementation.

In LTE networks a proper P₀ setting is essential to achieve efficient performance. The best suited P₀ depends among others on the traffic load in the network. Thus, according to an embodiment of the invention, an analysis of the impact of P₀ and traffic load and a determination of best suited P₀ as a function of the traffic load is carried out. Further, the traffic load of the considered cell is used for triggering dynamic UL transmission power adaptation for UEs served in this cell.

In the following there will be described exemplary embodiments of the present invention.

According to an exemplary embodiment of the invention, the method further comprises determining the trigger point based on one or more of conditions consisting of the group of current traffic load, number of user equipments located in the cell, number of active bearer channels in the cell, resource block (RB) utilization, noise rise, weights of services of Quality of Service (QoS) requirements, specified weights of Guaranteed Bit Rate services and non-Guaranteed Bit Rate services.

The latter aspect may be performed by a counter to sum up the weights of different service types using specific weights for services of different QoS requirements and mapping on a common scale e.g. corresponding to the number of served best effort services. Further, different weights for Guaranteed Bit Rate (GBR) services (depending on requested data rate) and non-GBR services may be used.

According to a further exemplary embodiment of the invention, the trigger point is determined by a combination of the conditions, wherein the conditions are differently weighted.

Weighting factors or priority definitions may be used to avoid conflicts of the outputs of different trigger conditions, i.e. quality condition triggering power increase while load condition requests power decrease shall result in a clear action defined by weighting of the input conditions.

According to a further exemplary embodiment of the invention, controlling the uplink transmission power of the user equipment comprises adapting the uplink transmission power of the user equipment.

Adapting in this context may denote an increasing or decreasing of the uplink transmission power of the user equipment. This may be dependent on the current determined traffic load within the cell or other trigger conditions defined in one of the further embodiments. Traffic load may be determined by one of or a combination of the above mentioned trigger conditions

According to a further exemplary embodiment of the invention, controlling the uplink transmission power of the user equipment comprises commanding information about uplink transmission power adaptations via broadcast channels.

Here, transmission power changes may be commanded via broadcast parameter (P₀_{_{—}}_{NOMINAL}_{_{—}}_{PUSCH}), via dedicated RRC signaling (P₀_{_{—}}_{UE}_{_{—}}_{PUSCH}), or via closed-loop power correction values using PDCCH to adapt the total transmission power on traffic load.

According to a further exemplary embodiment, controlling the uplink transmission power of the user equipment comprises commanding information about uplink transmission power adaptations via dedicated signaling. This may be carried out for example via RRC-DCCH.

According to a further exemplary embodiment of the invention, controlling the uplink transmission power comprises calculating desired differences of the uplink transmission power based on the current traffic load.

These differences of relative transmission power may be commanded to the UEs based on traffic load evaluation.

According to a further exemplary embodiment of the invention, controlling the uplink transmission power is carried out with closed-loop power commands.

The CL component may be used for command to the user equipment a power correction determined based on traffic load. Thus, Δi values according to equation (1) may be commanded as load dependent power offset.

The dynamic transmission power adaptation may be applied by evaluation of the user's location and combination with the traffic load based triggering of transmission power adaptation executed via the closed-loop PC component. This characteristic may allow to assign high SINR and RSSI targets in the closed-loop PC component to UEs in the vicinity of the eNodeB.

The Δi values may be determined by different criteria and algorithms. Possible outputs for Δi may be for example −1 dB, 0 dB, +1 dB or +3 dB.

An increase or decrease of the transmission power may be triggered by a comparison of the current transmission power with a load dependent target value. The value of Δi may be dependent on the difference of these both values, i.e. on the result of the comparison.

One further trigger condition may be the position of the user. In common procedures, positioning methods are used, which are based on run time differences and wherein the position is determined for example by triangulation (e.g. GPS, TOA, E-OTD) evaluation of Timing Advance Values or PL measurements. According to the present invention, the position of the user may be used optionally, for commanding an increase or decrease, i.e. an adaptation, of the transmission power via the Closed-Loop component. Thus it may be realized that user equipments in the proximity of the base station use a higher transmission power (and thus a higher SINR and higher MCS), whilst the transmission power of user equipments in higher distance to the base station is reduced. This may be combined with the existing Closed-Loop component, which uses SINR and RSSI as decision criteria for an increase or decrease of the transmission power.

According to a second aspect of the invention there is provided a user equipment for dynamically controlling an uplink transmission power, wherein the user equipment is assigned to a base station within a cell of a mobile network, and wherein the user equipment comprises a first unit for receiving information indicative about a current traffic load of the cell from the base station, a second unit for receiving a trigger signal in response to a specified trigger point for adapting the uplink transmission power of the user equipment, and a third unit for controlling the uplink transmission power of the user equipment in response to the triggering and depending on the current traffic load.

According to a further aspect of the invention, there is provided a base station for dynamically controlling an uplink transmission power of a user equipment assigned to the base station within a cell of a mobile network, wherein the base station comprises a first unit being adapted for determining a current traffic load within the cell, a second unit for triggering in response to a specified trigger point an adaptation of the uplink transmission power of the user equipment, and a third unit for controlling the uplink transmission power of the user equipment in response to the triggering and depending on the current traffic load.

According to a further aspect of the invention, there is provided a system for dynamically controlling an uplink transmission power of a user equipment assigned to a base station within a cell of a mobile network, wherein the system comprises a user equipment with the above mentioned features and a base station with the above mentioned features.

According to a further embodiment of the invention, the base station and the user equipment are adapted to exchange messages for performing a method for dynamically controlling an uplink transmission power of the user equipment assigned to a base station within a cell of a mobile network.

With this embodiment, a dynamic system may be provided. The uplink transmission power of the user equipment may be dynamically controlled and adapted by exchanging messages between the user equipment and the base station.

According to a further aspect of the invention, a program element (for instance a software routine, in source code or in executable code) is provided, which, when being executed by a processor, is adapted to control or carry out a controlling method having the above mentioned features.

According to yet another aspect of the invention, a computer-readable medium (for instance a CD, a DVD, a USB stick, a floppy disk or a hard disk) is provided, in which a computer program is stored which, when being executed by a processor, is adapted to control or carry out a controlling method having the above mentioned features.

Dynamically controlling an uplink transmission power of a user equipment which may be performed according to aspects of the invention can be realized by a computer program, that is by software, or by using one or more special electronic optimization circuits, that is in hardware, or in hybrid form, that is by means of software components and hardware components.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1 shows a mobile network according to an embodiment of the invention.

FIG. 2 shows a diagram illustrating a cumulative distribution function of transmission power for various power offsets.

FIG. 3 shows a diagram illustrating a cumulative distribution function of number of allocated resource blocks per user equipment for various power offsets.

FIG. 4 shows a diagram illustrating a cumulative distribution function of Signal over Interference plus Noise Ratio for various power offsets.

FIG. 5 shows a diagram illustrating a throughput per resource block versus Signal over Interference Plus Noise Ratio.

FIG. 6 shows a diagram illustrating a cumulative distribution function of modulation and coding scheme utilization for various power offsets.

FIG. 7 shows a diagram illustrating a cumulative distribution function of cell throughput depending on power offsets.

FIG. 8 shows a diagram illustrating an optimum P0 as a function of traffic load.

FIG. 9 shows a diagram illustrating a shift of an SINR/RSSI based decision matrix.

### DETAILED DESCRIPTION

The illustration in the drawing is schematically. It is noted that in different figures, similar or identical elements are provided with reference signs, which are different from the corresponding reference signs only within the first digit.

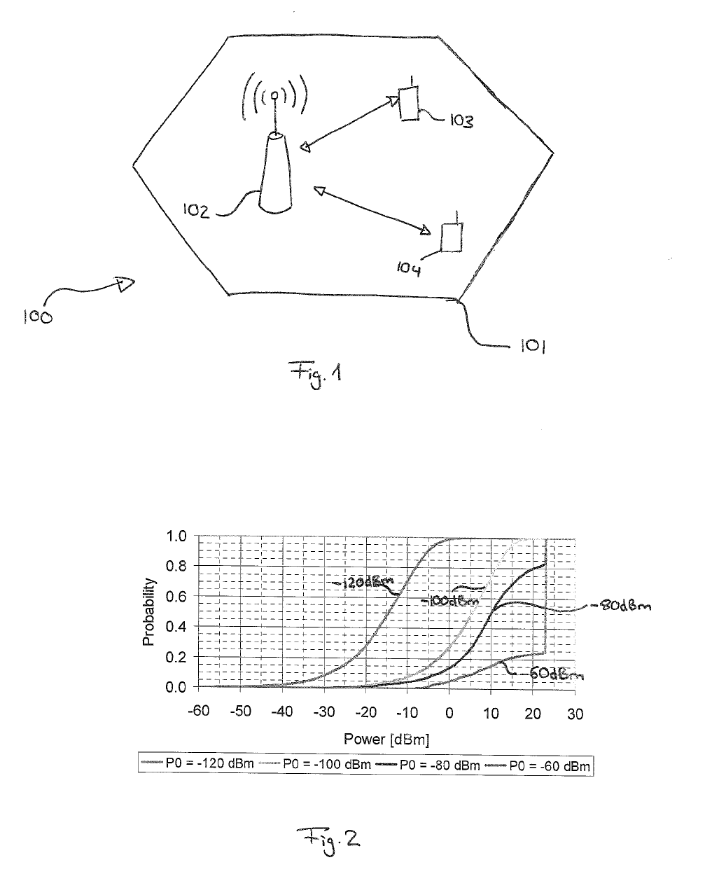

FIG. 1 shows a mobile network 100 according to an embodiment of the invention. The mobile network 100 comprises at least one cell 101. A base station or eNodeB 102 is located in and assigned to this cell. One or more user equipments 103, 104 are connected to the base station. When the uplink transmission power of the user equipment 104 should be dynamically controlled, a current traffic load within the cell is determined, that means the traffic load of the complete cell with all user equipments. In response to a specified trigger point, an adaptation of the uplink transmission power of the user equipment is triggered. Subsequently, the uplink transmission power of the user equipment is controlled and/or adapted in response to the triggering and depending on the current traffic load.

In the following, common procedures in comparison with the procedures according to embodiments of the invention are described. The Internet has become a major delivery platform for text, music, video and other multimedia content. More and more mobile radio users will enjoy multimedia services thus increasing the total bandwidth demand in mobile networks. With the perspective to make the next evolutionary step beyond High-Speed Packet Access (HSPA), 3GPP Release 8 has standardized Long Term Evolution (LTE) providing mobile broadband access with high data rates and low latency. In the network performance Power Control (PC) plays an important role for both maintaining a desired Signal over Interference plus Noise Ratio (SINR) according to Quality of Service (QoS) requirements and controlling the interference. Especially uplink (UL) PC is a means to effectively reduce interference in the network and to improve cell edge performance. This is of particular importance considering the fact that typical LTE deployments will have a frequency reuse 1. Due to the low transmission power of the User Equipment (UE) (e.g. 23 dBm for UE power class 3) the UL is the limiting link to balance throughput. Any improvement for the UL throughput provides important LTE performance improvements.

The total transmission power of the UE can be distributed over many resource blocks (RB) resulting in low SINR and consequentially low number of transmitted user bits per RB or it can be distributed over a low number of RB with high SINR and user bits per RB. The best strategy depends on traffic load conditions. The aim of this invention is the definition of trigger conditions for the optimization of the UL transmission power based on traffic load, cell environment and quality aspects and its dynamic adaptation. The idea results from detailed studies of the interworking between UL PC, Adaptive Transmission Bandwidth (ATB), and Adaptive Modulation and Coding (AMC). This invention can be applied for both modes of LTE operation, Time Division Duplex (TDD) and Frequency Division Duplex (FDD).

The above mentioned common LTE PC algorithm is based on a combination of open-loop (OL) and closed-loop (CL) schemes. The UE controls its output power such that the power per RB is kept constant irrespective of the allocated transmission bandwidth. One RB is the smallest scheduling unit occupying a bandwidth of 180 kHz and a Transmission Time Interval (TTI) of 1 ms. OLPC is performed autonomously by the UE and can compensate for long-term channel variations such as path-loss (PL) changes and shadowing, but its performance typically degrades due to errors in UE PL estimates. CLPC is less sensitive to these errors due to feedback control from the LTE base station (eNodeB) based on measurements and control commands. CLPC performance degrades during UL transmission breaks due to lack of measurements as well as in case of outdated control information, e.g. due to high UE speed. As long as there is no PC command received from eNodeB on the Physical Downlink Control Channel (PDCCH), the UE exclusively performs OLPC based on PL estimates, broadcast system parameters and dedicated signalling. Whenever the UE receives a CLPC command from eNodeB via PDCCH the UE has to correct its transmission power, if necessary. In general the transmission power for the Physical Uplink Shared Channel (PUSCH) is set by the UE according to the equation (1).

In the following, interworking between Uplink Power Control, Adaptive Transmission Bandwidth (ATB) and Adaptive Modulation and Coding (AMC) is described. ATB is based on Power Headroom Reports (PHR) and sets the number of allocated RBs according to available UL power and cell load. The Power Headroom (PH) is defined as the difference of maximum transmission power and actual used transmission power, i.e. PH=Pₘₐₓ−P. Adjustment of the bandwidth assigned to a specific UE by ATB is required whenever the UE power headroom indicates that UE has still some transmission power reserve or in case the UE runs out of power. For example, a UE has an allocation of 10 UL RBs and PHR indicates +3 dB (power reserve), hence ATB extends upcoming allocation to 20 UL RBs. On the other hand a power headroom of −3 dB will reduce upcoming allocation down to 5 UL RBs. ATB is necessary to avoid UE overheating and especially in case of lack of power to concentrate the available power on less RBs, thus allowing a regular data transmission in UL even at the cell edge.

The higher the transmission power per RB, the lower is the PH for given number of assigned RB. This behaviour is demonstrated by simulations for OLPC (Δᵢ=0) assuming full PL compensation (α=1) and transport format dependent offset Δ_{TF} set to zero, i.e. modulation and coding scheme (MCS) independent. The total UL transmission power in (1) has been varied by variation of the parameter P₀, for which values between −120 dBm and −60 dBm have been selected.

FIG. 2 shows the cumulative distribution function (CDF) of the transmission power per RB. For low total received power (P₀=−120 dBm and P₀=−100 dBm) the total UL transmission power according to (1) is low and the transmission power per RB is not limited. In contrast, at higher power offset (e.g. P₀=−80 dBm) 17% of the RBs reach Pₘₐₓ, i.e. the requested transmission power according to (1) cannot be provided even for the allocation of a single RB only. For P₀=−60 dBm limitation of transmission power per RB has been observed for 76% of the RBs. Hence proper cell-specific setting of P₀ is essential, especially if pure OLPC is applied. If P₀ is set too high, not only UEs located at the cell border, but also those in the vicinity of the eNodeB use unnecessarily high transmission power reducing battery life-time and get less bandwidth assigned by ATB.

The number of RBs assigned in UL to the UE depends on (a) the availability of physical resources (bandwidth) in the cell and (b) the available power headroom.

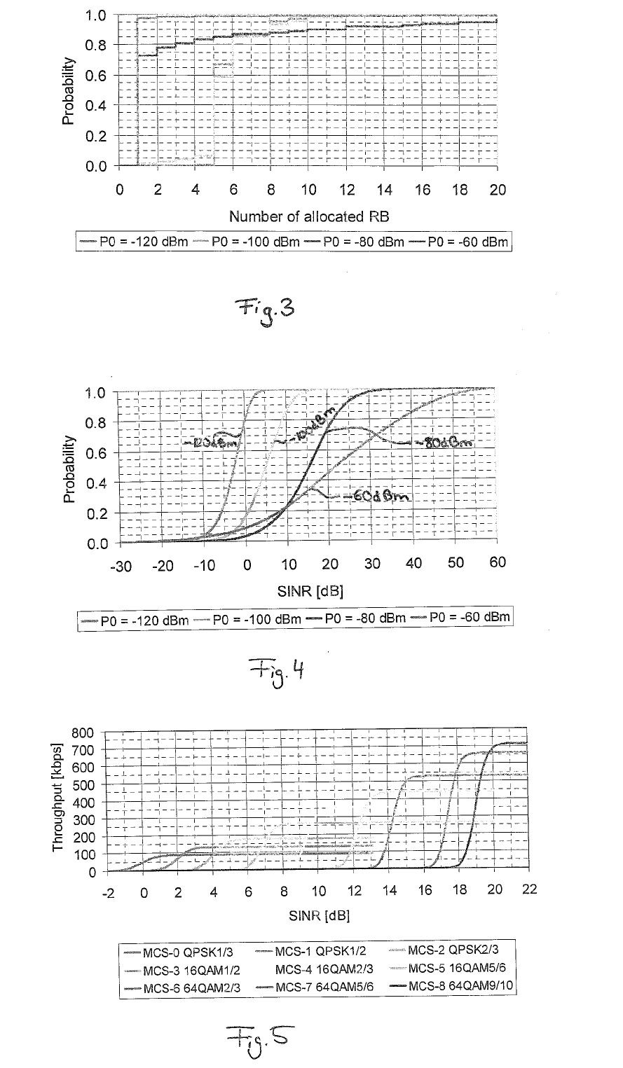

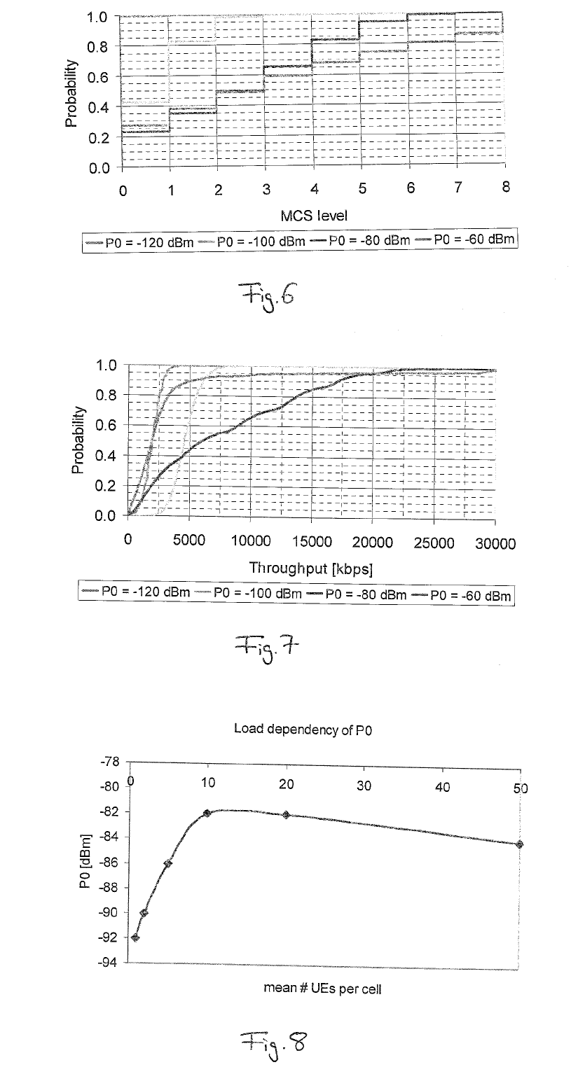

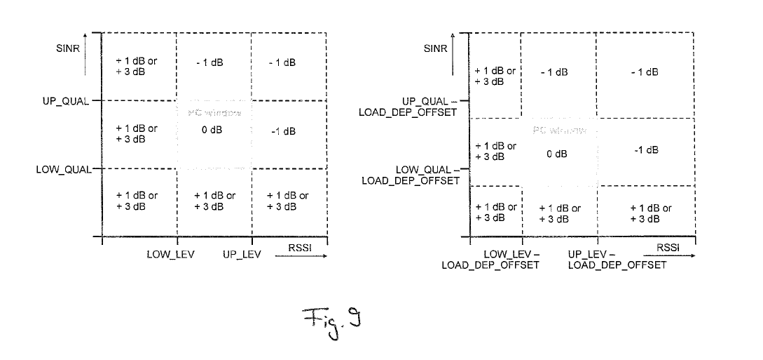

The CDF of the number of allocated RBs per UE and TTI is shown in FIG. 3. For P₀=−120 dBm five or more RBs have been assigned to the UE in 99.7% of the TTIs. A restriction in the number of assigned RBs is purely related to the number of users simultaneously served in the cell and not to UL power constraints. In this scenario 50 RBs available in 10 MHz are shared by 10 UEs per cell in average.

For P₀=−100 dBm five or more RBs have been assigned to the UE in 94% of the TTIs. Selecting higher P₀ results in a higher transmission power per RB and consequently leads to a reduction of the RBs assigned to the UE by ATB, because the total UE transmission power defined in (1) must not exceed Pₘₐₓ. For P₀=−80 dBm only a single RB has been assigned to the UE in 73% of the TTIs. For P₀=−60 dBm the ratio of TTIs for which only a single RB has been assigned to the UE is even 98%. Note that 10 UEs per cell with a single RB allocated per UE results in a fractional load of 20% only.

FIG. 3 demonstrates the utilization of the deployed air interface resources depending on P₀ setting.

LTE supports in UL Quadrature Phase-Shift Keying (QPSK) and 16 Quadrature Amplitude Modulation (QAM), 64QAM is optional. Switching between different modulation and coding schemes is performed by AMC. The transmission power per RB has impact on the Signal to Interference plus Noise Ratio (SINR), which is a measure of the radio quality. The different MCS differ in their amount of transmitted user data. The appropriate MCS is selected by AMC depending on radio conditions and thus the transmission power per resource block has impact on the resulting throughput per RB.

Transmission power per RB and number of assigned RBs have significant impact on the SINR as shown in FIG. 4. In the fully loaded network using P₀=−120 dBm only 13% of the bursts are received at a SINR of 1 dB or higher, corresponding to the operating point of the most robust MCS-0 used in this study (see FIG. 5). The SINR distribution gradually improves as P₀ increases to −100 dBm and −80 dBm. For P₀=−60 dBm the high interference at a low number of allocated RBs (see FIG. 3) causes flattening of the SINR distribution, i.e. a considerable number of users enjoy high SINR, while other users suffer from low SINR resulting in a poor cell border throughput performance. Note that for P₀=−60 dBm in most cases only one RB per UE has been assigned, i.e. the SINR distribution reflects the quality on the sparse number of allocated resources only.

FIG. 5 shows the throughput per RB for the first transmission versus SINR obtained from link level simulations. The operating range of QPSK modulation is 1 to 7 dB. For 16QAM a SINR of 7 to 15 dB is required. The operating point of 64QAM is 15 dB and higher.

The optimum MCS per UE depends on radio conditions and is selected by AMC based on link quality measurements. For P₀=−120 dBm the resulting SINR (see FIG. 4) is typically too low for selecting a high MCS and hence MCS-0 is dominating.

The CDF of MCS level per allocated code word in FIG. 6 shows that for P₀=−120 dBm almost 100% of the UEs use MCS-0. For P₀=−100 dBm the ratio of MCS-0 utilization is 43%. For this P₀ setting still almost 100% QPSK utilization has been observed. For P₀=−80 dBm the SINR is substantially higher and hence the percentage of QPSK modulation is only 50%, while further 45% of the code words have been transmitted in 16QAM. The ratio of 64QAM utilization is limited to 5%. In contrast for P₀=−60 dBm a 64QAM utilization of 25% has been determined.

Two contradicting effects occur: High transmission power per RB is required to achieve high SINR and for selecting a high MCS level which results in a high number of transmitted user bits per RB. On the other hand high transmission power per RB leads to a low number of allocated RB due to UL power constraints.

The combination of these effects is shown in FIG. 7 demonstrating the CDF of the cell throughput. Both extreme cases P₀=−120 dBm and P₀=−60 dBm show poor performance for the above mentioned reasons. Highest UL cell throughput is provided by P₀=−80 dBm.

In the following, the problem solved by this invention is described. In LTE networks a proper P₀ setting is essential to achieve efficient performance. The best suited P₀ depends among others on the traffic load in the network.

It has been found out when analyzing the mean cell throughput in kbps depending on P₀ for various traffic load:
At low traffic load (1 UE per cell in average) a low P₀ value provides best performance. In this situation the low UL transmission power results in a relatively low SINR, but the assignment of a higher bandwidth (high number of RB) provides higher throughput than using a higher transmission power per RB with high MCS-level but allocating less RBs (in order to cope with the UL power constraints according to (1)). With this strategy high code gain by turbo codes is achieved by distributing the transmission over multiple RBs.
With increasing traffic load and distribution of the cell resources among the UEs served in the cell, more and more emphasis is placed to traffic load as the limiting factor for throughput. The resources in the cell are distributed among the served users and the maximum UL transmission power is sufficient for the lower number of assigned RBs per UE, i.e. throughput limitation due to UL power constraints becomes less important.
In case of high traffic load higher transmission power (here controlled by P₀) provides advantages: The number of assigned RB is low and a higher transmission power per RB leads to higher quality on the radio link and finally to a utilization of a higher MCS-level, which allows to transport a higher amount of user bits per given time period.
The increase of transmission power per RB for increasing traffic load to achieve highest cell throughput is continued until the turn-over point is reached (here at 20 UEs per cell in average). With increasing traffic load also the interference in the network grows, which leads to lower quality on the radio channel and hence lower MCS-level and lower throughput. For this reason a reduction of the transmission power at very high load is beneficial.

The observed behaviour can be summarized as follows: The transmission power of the UE is limited and can be distributed either over a low number of RBs achieving high SINR and high throughput per RB or it can be distributed over a high number of RBs with low SINR and low throughput per RB. The latter strategy is beneficial for low traffic load situations, i.e. sufficient vacant RB available in the cell. This option achieves a high code gain and the resulting cell throughput is higher than that obtained by using higher transmission power per RB but allocating a low number of RBs. With increasing traffic load the use of higher total transmission power is beneficial. In this situation the user throughput is mainly restricted by the number of users sharing the limited number of cell resources. In this situation the higher transmission power allows taking benefit from the higher MCS due to the high SINR.

FIG. 8 shows the dependency of P₀ on traffic load for achieving highest mean cell throughput. The dynamic adaptation of the transmission power to the traffic load is the central idea of this invention.

In the following, an embodiment according to the invention is described. It is proposed to adjust the transmission power based on the traffic load in the cell. The trigger point is the comparison of one or a combination of the following conditions with configurable thresholds:
Number of UEs served in the cell
Number of active bearers per cell
Counter to sum up the weights of different service types using specific weights for services of different QoS requirements and mapping on a common scale e.g. corresponding to the number of served best effort services
Different weights for Guaranteed Bit Rate (GBR) services (depending on requested data rate) and non-GBR services

Optionally specific load ranges may be mapped to separate groups defining e.g. very low, low, medium and high load. Adaptation of transmission power shall be performed in these steps. This option allows a simple handling of the non-linear dependency between optimum P₀ and number of UEs shown in FIG. 8. Example: very low load (0 to 4 UEs per cell); low load (5 to 8 UEs per cell); medium load (9 to 20 UEs per cell) and high load (more than 20 UEs per cell).

The adaptation of the transmission power may be performed according to FIG. 8 or any other function defining the target transmission power, a target transmission power offset or relative transmission power adjustment depending on traffic load.

The adaptation of the total UL transmission power for PUSCH can be done by adaptation of
(a) Cell-specific nominal component P₀_{_{—}}_{NOMINAL}_{_{—}}_{PUSCH}, which is broadcasted via System Information Broadcast (SIB). Its range is [−126 dBm; 24 dBm]. The drawback of this option is its inertia and the low number of broadcast parameter modifications per time interval.
(b) UE specific component P₀_{_{—}}_{UE}_{_{—}}_{PUSCH}, which is a dedicated RRC parameter that can be varied in the range [−8 dB; 7 dB] in 1 dB granularity. Proper setting of P₀_{_{—}}_{NOMINAL}_{_{—}}_{PUSCH} is essential to guarantee that the smaller range of [−8 dB; 7 dB] fully compensates the deviation between calculated total transmission power in (1) and desired transmission power according to traffic load. The drawback of this option is the performance degradation in case of high number of UEs and frequent dedicated RRC signalling. To cope with hardware restrictions commanding of new P₀_{_{—}}_{UE}_{_{—}}_{PUSCH} values can be limited to new connections, i.e. dedicated RRC signaling only at connection setup and the UE keeps this P₀ until connection release. This is not an optimum solution especially for UEs being always connected and having always some activity over hours, because those will not be released.

P₀ in (1) is composed of the cell-specific and UE specific components (a) and (b), i.e. P₀=P₀_{_{—}}_{NOMINAL}_{_{—}}_{PUSCH}+P₀_{_{—}}_{UE}_{_{—}}_{PUSCH}. Due to the above mentioned drawbacks another option is proposed that leads to the same result. Equation (1) includes different offset parameters for the calculation of the total trans-mission power set by the UE.
(c) Instead of a dynamic adaptation of P₀ the power correaction value Δᵢ provided by the closed-loop component shall be used to adapt the UL transmission power according to the current traffic load. Closed-loop power correction values are calculated by the eNodeB and sent to the UE via PDCCH and allow for frequent changes. Accumulation of closed-loop power control commands for accumulationEnabled==TRUE allows covering a large range for power adaptation. In each single step one of the values {−1 dB; 0 dB; 1 dB; 3 dB} can be commanded. Alternatively the set {−1 dB; +1 dB} can be applied. According to FIG. 8 a load dependent modification of the total transmission power by −5 dB to +5 dB is reached by three closed-loop intervals within a few ms (depending on averaging window size)

Optionally the decision matrix for the closed-loop component currently using e.g. the triggers quality (defined by SINR measurements) and signal level (defined by the Received Signal Strength Indicator (RSSI)) may be adapted to use traffic load as further trigger for closed-loop PC commands.

In present LTE systems, the correction values Δᵢ are determined by comparing the filtered RSSI and SINR measurements with configurable thresholds representing a two-dimensional decision matrix. A further dimension may be added to the decision matrix to use traffic load as further criterion. In combination the lower and upper thresholds define a three-dimensional PC window. Δᵢ=0 dB is commanded to the UE if the measurements are within the PC window. Power decrease of Δᵢ=−1 dB is commanded if all components or parts of them exceed the PC window while the other one(s) does not fall below the lower threshold(s). If the filtered measurements of at least one of the component falls below the PC window, power increase Δᵢ=+1 dB or Δᵢ=+3 dB, respectively, may be commanded, depending on the deviation of measurements from lower thresholds. The update interval may be selectable via O&M.

Weighting factors may be used to avoid conflicts of the outputs of different trigger conditions, i.e. quality condition triggering power increase while load condition requests power decrease shall result in a clear action defined by weighting of the input conditions.

Alternatively priorities may be assigned to the different trigger conditions, i.e. a trigger condition of higher priority may override the request of a lower priority trigger condition. In the above example the request of power increase by the quality criterion shall be ignored and power decrease shall be commanded to the UE as requested by the load criterion if higher priority has been assigned to the load criterion.

Alternatively the two-dimensional PC window defined by the quality and signal level component shall be shifted by the power adaptation value defined by the load component according to FIG. 9. The left diagram shows a decision matrix of present LTE systems. The parameter LOAD_DEP_OFFSET may be used to shift the thresholds of one or both components, SINR and RSSI. The value LOAD_DEP_OFFSET may be calculated as the difference between UL transmission power according to (1) and desired UL transmission power considering the current traffic load in the cell, e.g. if the best suited total transmission power according to FIG. 8 for actual traffic load is 3 dB lower than the reference point, the PC window shall be shifted by 3 dB, i.e. the thresholds UP_QUAL, LOW_QUAL, UP_LEV and LOW_LEV shall be reduced by 3 dB thus requesting power decrease by the RSSI or SINR component by 3 dB.

The diagram on the right side of FIG. 9 shows a decrease of the PC window resulting from transmission power reduction requested from the load component, i.e. for unchanged radio conditions the components quality and signal level will trigger further power decrease. This option is an alternative solution to the use of traffic load as the third dimension of the decision matrix.

The functional relation between power increase/decrease and traffic load shall include an adjustable sensitivity (weighting) factor in the range [0; 1], with 0=>load dependent thresholds corresponding to some static (O&M) adjustable values and 1=>fully load dependent thresholds.

The described procedure for dynamic transmission power adaptation may be enhanced to compensate effects resulting from different cell sizes. The path loss of the connection can be determined from the PHR and the UL receive signal level using parameters such as number of assigned RB, offsets etc., which are known by eNodeB.

The described procedure may be enhanced by using the user's location for controlling the UL transmission. UEs in the vicinity of the eNodeB shall use higher quality and signal level targets than UEs at the cell border. In this option the shift of the PC window is commanded to each individual UE based on its path-loss to the serving eNodeB. Note that in present LTE systems, the closed-loop component defines the correction values independent of the user's position and UEs in the proximity of the eNodeB do not profit from extremely good radio conditions.

The described procedures are not limited to PUSCH and can also be applied to optimize the transmission power on the Physical Uplink Control Channel (PUCCH) and Sounding Reference Symbol (SRS).

According to an embodiment of the invention, the following steps are carried out:
Analysis of the impact of total transmission power or power offset e.g. P₀ and traffic load and determination of best suited total transmission power or power offset, e.g. P₀, as a function of the traffic load.
Using traffic load of the considered cell for triggering dynamic UL transmission power adaptation for UEs served in this cell.
Calculation of relative transmission power differences to be commanded to the UEs based on traffic load evaluation.
Commanding of transmission power changes via broadcast parameter (P₀_{_{—}}_{NOMINAL}_{_{—}}_{PUSCH}), via dedicated RRC signalling (P₀_{_{—}}_{UE}_{_{—}}_{PUSCH}), or via closed-loop power correction values using PDCCH to adapt the total transmission power on traffic load.
Extension of the closed-loop PC decision matrix by the load condition. Definition of priorities to avoid conflicts between contradicting commands of single trigger points.
Application of dynamic transmission power adaptation by evaluation of path-loss information to compensate effects resulting from different cell sizes.
Application of dynamic transmission power adaptation by evaluation of the user's location and combination with the closed-loop PC component. This characteristic allows assigning high SINR and RSSI targets in the closed-loop PC component to UEs in the vicinity of the eNodeB.
Application of the above described means for dynamic power adjustment to PUSCH, PUCCH and SRS.

Up to now this problem in the LTE UL has not been solved. It has been detected by extensive simulation campaigns and detailed performance analysis of the interworking between PC, ATB and AMC. In present LTE systems the P₀ value is set semistatically and a load dependent adaptation is not performed. Simulations have shown that for specific traffic load conditions assignment of a higher bandwidth at lower transmission power per RB provides significant advantages compared to higher transmission power per RB on a lower number of RBs. The proposed embodiments of the invention provides an automatically configured system. AMC operates autonomously based on link quality. The interworking between PC and ATB is optimized and the essential benefit is that the adjustment of the transmission power is based on measurements done in the serving cell and no interaction to other nodes is necessary.

A load-hiking closed-loop power control, i.e. load dependent generation of closed-loop power control commands realized by load-dependent migration of the power control window for closed-loop power control using dynamic adaptation of the relevant thresholds to the current load experienced in the cell are proposed. The dynamic adjustment of the thresholds may be based on a functional relation with the continuously estimated cell load. The said functional relation can be deduced from performance analysis based on system level simulations. The functional relation may include an adjustable sensitivity (weighting) factor in the range [0; 1], with 0=>load dependent thresholds corresponding to some static (O&M) adjustable values and 1=>fully load dependent thresholds.

At low load it may be more advantageous for the throughput performance to assign a high number of resource blocks at low SINR rather than to try to improve SINR in order to use higher modulation and coding schemes. This means that at low load the power control window shall migrate to lower targets. The way how this migration is done is the task of the functional relation.

At very high load due to the limited number of resource blocks available in the cell each UE is allocated in many cases a single resource block and this is why it is reasonable to request high SINR in order to make the best out of the available resources. Consequently the power control window shall migrate to the upper right corner of the decision matrix, i.e. transmission power shall be increased.

Further trigger conditions may be path-loss between UE and serving eNodeB as well as location of the user. These trigger conditions shall be combined with existing conditions via weighting factors or priorities to be operated in coexistence with present closed-loop PC decisions. As a result an automatic control of the bandwidth allocation strategy by dynamic adaptation of the transmission power is achieved leading to an optimization of the throughput in the network without intervention of the operator. The invention can be applied to FDD and TDD mode in LTE networks

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1. A method for dynamically controlling an uplink transmission power of a user equipment assigned to a base station within a cell of a mobile network, the method comprising
determining a current traffic load within the cell, triggering in response to a specified trigger point an adaptation of the uplink transmission power of the user equipment, and
controlling the uplink transmission power of the user equipment in response to the triggering and depending on the current traffic load.

2. The method as set forth in claim 1, further comprising determining the trigger point based on one or more of conditions consisting of the group of current traffic load, number of user equipments located in the cell, number of active bearer channels in the cell, noise rise, weights of services of Quality of Service requirements, specified weights of Guaranteed Bit Rate services and non-Guaranteed Bit Rate services.

3. The method as set forth in claim 2, wherein the trigger point is determined by a combination of the conditions, wherein the conditions are differently weighted.

4. The method as set forth in claim 1, wherein
controlling the uplink transmission power of the user equipment comprises
adapting the uplink transmission power of the user equipment.

5. The method as set forth in claim 1,
wherein controlling the uplink transmission power of the user equipment comprises commanding information about uplink transmission power adaptations via broadcast channels.

6. The method as set forth in claim 1,
wherein controlling the uplink transmission power of the user equipment comprises commanding information about uplink transmission power adaptations via dedicated signaling, e.g. via RRC-DCCH.

7. The method as set forth in claim 1, wherein
controlling the uplink transmission power comprises calculating desired differences of the uplink transmission power based on the current traffic load.

8. The method as set forth in claim 1, wherein controlling the uplink transmission power is carried out with closed-loop power commands.

9. A user equipment for dynamically controlling an uplink transmission power, wherein the user equipment is assigned to a base station within a cell of a mobile network, the user equipment comprising
a first unit for receiving information indicative about a current traffic load of the cell from the base station,
a second unit for receiving a trigger signal in response to a specified trigger point for adapting the uplink transmission power of the user equipment, and
a third unit for controlling the uplink transmission power of the user equipment in response to the triggering and depending on the current traffic load.

10. A base station for dynamically controlling an uplink transmission power of a user equipment assigned to the base station within a cell of a mobile network, the base station comprising
a first unit being adapted for determining a current traffic load within the cell,
a second unit for triggering in response to a specified trigger point an adaptation of the uplink transmission power of the user equipment, and
a third unit for controlling the uplink transmission power of the user equipment in response to the triggering and depending on the current traffic load.

11. A system for dynamically controlling an uplink transmission power of a user equipment assigned to a base station within a cell of a mobile network comprising the user equipment as set forth in claim 9 and the base station further comprising
a first unit being adapted for determining a current traffic load within the cell,
a second unit for triggering in response to a specified trigger point an adaptation of the uplink transmission power of the user equipment, and
a third unit for controlling the uplink transmission power of the user equipment in response to the triggering and depending on the current traffic load.
